(19) United States
(12) Patent Application Publication
(10) Pub. No.: US 2022/0018948 A1
(43) Pub. Date: Jan. 20, 2022

(54) METHOD AND APPARATUS FOR RADAR IDENTIFICATION

(71) Applicant: Metawave Corporation, Carlsbad, CA (US)

(72) Inventors: Edmond Kia MEGERDICHIAN, Vista, CA (US); Taha SHAHVIRDI DIZAJ YEKAN, San Diego, CA (US); Armin Rainer VÖLKEL, Mountain View, CA (US); Kaice Theodore REILLY, San Diego, CA (US); Sandra Lynn GODSEY, Carlsbad, CA (US)

(21) Appl. No.: 17/011,886

(22) Filed: Sep. 3, 2020

Related U.S. Application Data
(60) Provisional application No. 62/895,450, filed on Sep. 3, 2019.

(51) Int. Cl. G01S 13/76; G01S 13/931

(52) U.S. Cl. CPC G01S 13/765; G01S 13/931; G01S 13/767

(57) ABSTRACT

An inductive system for vehicle information capture, having a radar module adapted to identify an echo signal having an amplitude over a threshold value, an interrogator module coupled to the radar module and adapted to initiate a radio frequency identification (RFID) information exchange when the amplitude is over the threshold value, a processor coupled to the radar module and the interrogator module, and a memory storage unit adapted to store RFID information. Examples disclosed herein provide methods and apparatus for vehicle sensors and vehicle identification.

### CROSS-REFERENCE TO RELATED APPLICATIONS

This application claims priority from U.S. Provisional Application No. 62/895,450, titled “METHOD AND APPARATUS FOR RADAR IDENTIFICATION,” filed on Sep. 3, 2019, and incorporated herein by reference in its entirety.

### BACKGROUND

As transportation continues to develop, there are opportunities for improving safe vehicle operation in an environment. This is accelerated with the spread of communication devices in the Internet of Things (IoT) and the demand for interconnectivity, which present many challenges to current communication systems. Transportation and communication intersect in the delivery and sensing spaces, which are overwhelmingly wireless. Autonomous vehicles require advanced sensors and capabilities to interface with communication systems and IoT devices.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 illustrates a transportation environment having components in accordance with various examples of the present disclosure;

FIG. 2 illustrates a reflectarray in accordance with various examples of the present disclosure;

FIG. 3 illustrates a transportation environment for vehicle interaction with infrastructure in accordance with various examples of the present disclosure;

FIGS. 4 and 5 illustrate interactions of a vehicle in a transportation environment as in FIG. 3 in accordance with various examples of the present disclosure;

FIG. 6 illustrates an inductive system for vehicle information capture in a transportation environment in accordance with various examples of the present disclosure;

FIG. 7 illustrates a communication system for information exchange with a vehicle in accordance with various examples of the present disclosure;

FIGS. 8, 9 and 10 illustrate a process for vehicle operation in a communication system, as in FIG. 7, in accordance with various examples of the present disclosure;

FIG. 11 illustrates a process for vehicle operation in response to a beacon signal in accordance with various examples of the present disclosure;

FIGS. 12, 13, 14, 15 illustrate a process for design of a reflectarray in accordance with various examples of the present disclosure;

FIG. 16 illustrates signal timing diagrams for various scenarios in accordance with various examples of the present disclosure;

FIG. 17 illustrates a sensor system in accordance with various examples of the present disclosure;

FIG. 18 illustrates a transportation environment with vehicles having multiple sensors and communication devices in accordance with various examples of the present disclosure;

FIG. 19 illustrates a transportation environment and vehicle with RFID capability in accordance with various examples of the present disclosure;

FIG. 20 illustrates a transportation infrastructure having RFID capability in accordance with various examples of the present disclosure; and

FIG. 21 illustrates a system in accordance with various examples of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology. In other instances, well-known methods and structures may not be described in detail to avoid unnecessarily obscuring the description of the examples. Also, the examples may be used in combination with each other.

FIG. 1 illustrates a transportation environment having components in accordance with various examples of the present disclosure. The environment 100 illustrates an instant in time where multiple vehicles are traveling in different directions, including vehicles 112, 102, with each vehicle having a sensor module configured on the vehicle. Vehicle 102 includes a sensor module 114 on a front end of the vehicle, while vehicle 112 includes a sensor module 110 on the rear of the vehicle. Within environment 100 are road signs for traffic regulation and control. A communication infrastructure element 106 is positioned along a side of the row and has a traffic control sign 108 affixed thereto. The communication infrastructure element 106 may be a base station, mini-base station or other module in a cellular communication system, such as in a 5G communication system, and may be configured for communication with vehicles, such as through wireless connectivity to modules in a vehicle. The sign 108 contains information for drivers to capture, which may be a traditional print medium for visual capture by a driver, a digital presentation for capture by a wireless communication system, may have reflective components for improved detection in a radar system, or other systems for presenting information to a vehicle.

The communication infrastructure element 106 may be a transceiver communicating with devices in the environment 100. Where a vehicle, such as vehicles 102, 112, have cellular capability, communications may be established to provide information exchange. In some examples, the vehicle 102 includes a global positioning system (GPS) to identify a location of the vehicle 102; the GPS information may be provided to the communication infrastructure element 106 by the cellular system or directly from the vehicle. The GPS information indicates where in the environment the vehicle 102 is located, enabling the communication infrastructure element 106 to direct communications to that location. The vehicle may also provide tracking information to indicate a planned path of the vehicle, velocity pattern of the vehicle, size of the vehicle, capabilities of the vehicle and so forth. This information may include a level of automation capability of the vehicle, such as defined by the Society of Automotive Engineers (SAE) (find reference), as given below.

Level 0 is the version with no driving automation where the human driver provides all the dynamic driving tasks. This level may have some systems to help the driver, for example an emergency braking system; however, these driver-assist functionalities do not control or drive the vehicle. Level 1 introduces driving automation with a single system, such as cruise control, including adaptive cruise control maintaining a distance between the vehicle and a next car. This is level one as the human driver continues to monitor the environment and control other aspects of driving. Level 2 increases the automation to assist the driver with an automated driver assist system (ADAS). The vehicle may control steering, acceleration, deceleration and so forth. This level requires a human driver to be ready to control the car at any time.

The next level moves from human monitoring of the driving environment to monitoring by an automated system. Level 3 is a large change, as these vehicles have environmental detection capabilities to make informed decisions. They still require human override capability. These vehicles are able to accelerate past a slow-moving vehicle, traffic navigation and so forth. Level 4 moves into a new area where the human driver has an option to override, but the automated system is capable of responding to system failures in most circumstances. These vehicles operate in self-driving mode. Most communities require Level 4 geofencing to limit the speed of Level 4 vehicles in urban environments. This is typically a ridesharing application of automation used for shuttles, cabs, taxis and so forth.

Finally, Level 5 vehicles do not have any human control and are not equipped with steering wheels, brake pedals and so forth. They do not require geofencing and are able to go anywhere an experienced human driver would take the vehicle. This is a goal of the automation technologies.

TABLE 1
Levels of Driving Automation

| | | | MONITORS |
|---|---|---|---|
| | | | DRIVING |
| LEVEL | TITLE | DESCRIPTION | ENVIRONMENT |
| 0 | NO | Manual control. The human | Human |
| | AUTOMATION | performs all driving tasks | |
| | | (steering, acceleration, | |
| | | braking, etc.) | |
| 1 | DRIVER | The vehicle features a | Human |
| | ASSISTANCE | single automated system | |
| | | (e.g. it monitors speed through | |
| | | cruise control) | |
| 2 | PARTIAL | ADAS. The vehicle can perform | Human |
| | AUTOMATION | steering and acceleration. The human | |
| | | still monitors all tasks and can take | |
| | | control at any time. | |
| 3 | CONDITIONAL | Environmental detection capabilities. | Automated System |
| | AUTOMATION | The vehicle can perform most driving | |
| | | tasks, but human override is still | |
| | | required. | |
| 4 | HIGH | The vehicle performs all driving tasks | Automated System |
| | AUTOMATION | under specific circumstances. | |
| | | Geofencing is required. Human | |
| | | override is still an option. | |
| 5 | FULL | The vehicle performs all driving tasks | Automated System |
| | AUTOMATION | under all conditions. Zero human | |
| | | attention or interaction is required. | |

As in FIG. 1, it is assumed that the vehicles are Level 2 or below, having some automation capabilities to assist the human driver. In addition to the communication and control information available through elements 106, 108, a reflectarray module 120 is positioned proximate the roadway. The reflectarray module 120 is configured to provide a specific control or information to a vehicle control system. For example, in some implementations, the reflectarray module 120 is positioned for detection by the vehicle's radar or lidar modules (not shown) such that the reflected signal has a higher gain or a specific parameter unique to the reflectarray module 120. This indicates to the vehicle that there is information or control provided at this location. This may indicate to a driver to observe the sign or may initiate a camera module in the vehicle to capture data, such as a speed limit. There are a large variety of scenarios available with such a configuration.

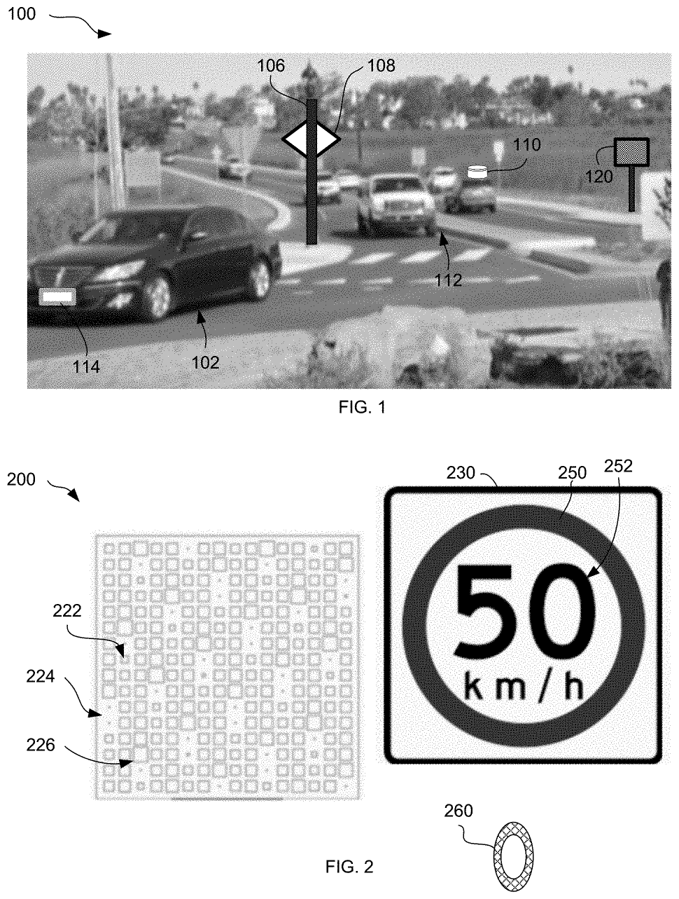

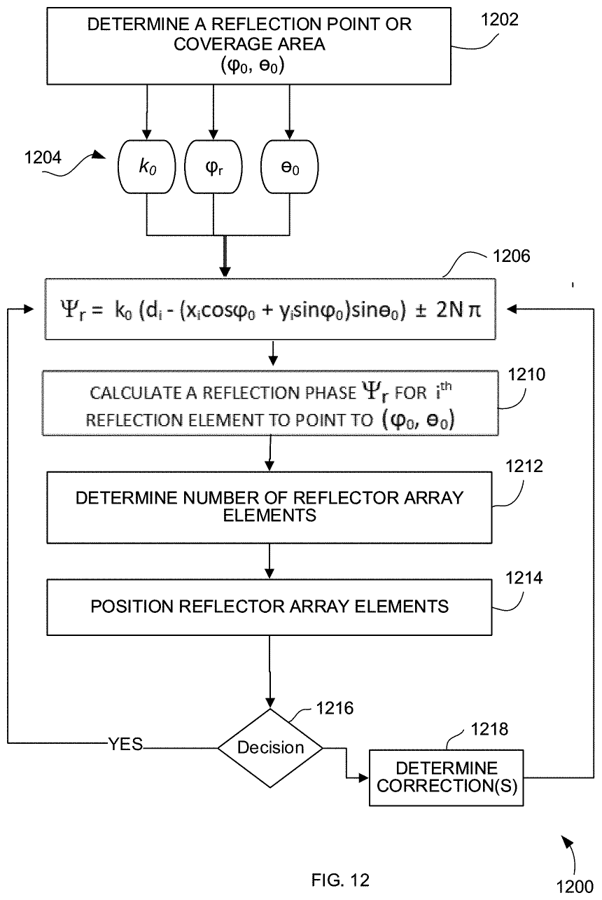

FIG. 2 illustrates a reflectarray 200 in accordance with various examples of the present inventions having a plurality of cells of various sizes, including a reflective cell 226, a space 224 with little reflectivity or no reflectivity, and smaller elements, such as cell 222. In the illustrated implementation, the reflectarray 200 is in a rectangular shape with reflective cells organized in columns and rows; alternate implementations may configure the reflective cells in a variety of different ways depending on desired application and constraints. FIG. 12 illustrates a method for determining the configuration and cell size of reflectarray 200. The reflectarray 200 is positioned with an environment, such as in FIG. 1, to reflect signals received from a first direction(s) and reflect these to a second direction(s). This may be used in a cellular system to redirect and route signals into areas that are not clear line-of-sight (LOS) with a transmitter, or base station; such areas are known as non-line-of-sight (NLOS) areas. Reflectarray 200 effectively increases the field of communication for a given transmitter. In the present application, reflectarrays are used to provide information to a vehicle by providing a relative differential in gain of a reflected signal. A reflection from the reflectarray 200 will return to a radar system at a much higher gain than the reflection of a car, truck, building and so forth. This higher gain indicates that there is a control or informational module in this location. The vehicle then has a variety of options for capturing that information.

The reflectarray 200 is typically composed of multiple cells, or reflective elements, and may be overlaid with information or a sign which hides the underlying cells. This is particularly useful to provide multiple ways to access the information contained in the reflectarray 200. In the illustrated implementation, a cover 230 indicates a speed limit and is overlaid on the reflectarray 200. In some implementations, the content of the cover does not correspond to the information contained in the reflectarray, such as where the cover is an advertisement for a product. And in some examples, the underlying information corresponds to an advertised product to enable selection and purchase options to the vehicle and/or driver.

In some examples a cover 230 includes a layer that contains a computer-readable code, such as an optical code, QR code, UPC or other method for storing information relating to the sign. Such layer may be comprised of a transparent reflective material. A code may be embedded into the visible marking on a sign, such as within the circle 250 around the number 252. An example is illustrated as code 260 within a number 0. The code may be implemented in the entire number of in a portion of the number. The code may be part of the visible portion of the number and so forth.

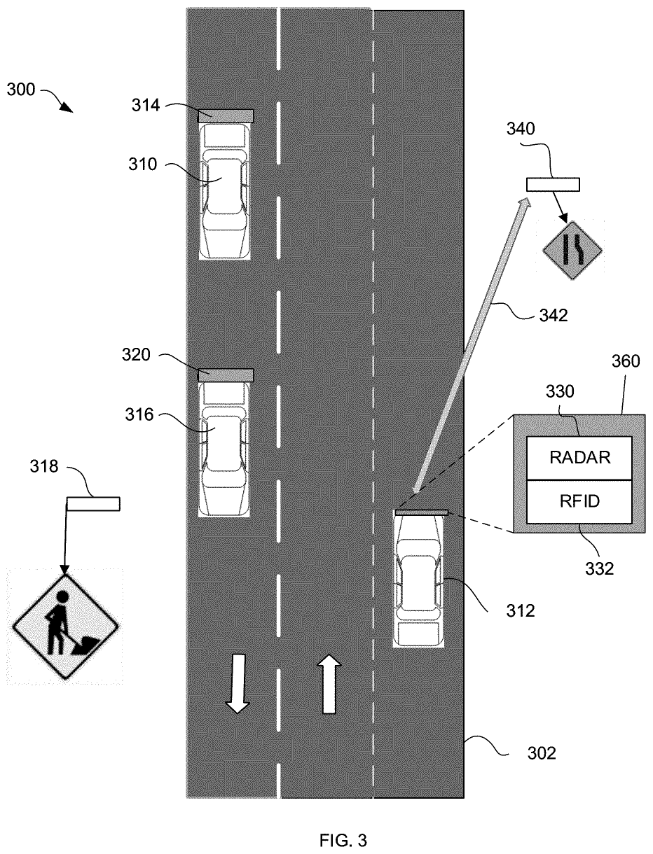

FIG. 3 illustrates a transportation environment 300 including a roadway 302 for vehicle interaction with infrastructure in accordance with various examples of the present disclosure. The vehicle 310 has a radar module 314 for object detection in the environment 300. The vehicle 316 includes an advanced radar module 320 for detecting objects with the radar module and for communicating with cellular systems in the environment. The advanced radar system 320 is able to interface with road signs having wireless communication capabilities, such as sign 318 indicating road work ahead. This information may be acquired by vehicle 316 alerting the driver and/or the automated vehicle control to be careful and reduce speed, take another route, or perform another action. A third vehicle 312 includes a sensor module 360 having a radar module 330 and inductive sensor 332, which in the illustrated implementation is a radio frequency identification (RFID) unit. The RFID module 330 of vehicle 312 is an RFID interrogator to read RFID tags in the environment and a radar module 330 to detect objects in the environment by radar waves. The RFID module 332 is adapted to read an RFID tag, such as the RFID tag 340 positioned along the roadway 302, wherein RFID tag 340 indicates a merging lane ahead. In RFID technology digital data is encoded in specially made tags or smart labels and then captured by a reader via radio waves. RFID is similar to barcoding in that data from a tag or label are captured by a device that stores the data in a database. The RFID tag data stored in sign 340 may be read from vehicles traveling along the road and from NLOS areas. The RFID technology is an automatic identification and data capture (AIDC) method to identify objects, collect data and process this data without human oversight. The system includes an RFID tag storing the information and an antenna, wherein the RFID tag interfaces with an RFID reader. The RFID tag includes an integrated circuit and antenna to transmit data to the RFID reader or interrogator which collects information for comparison to a database of information.

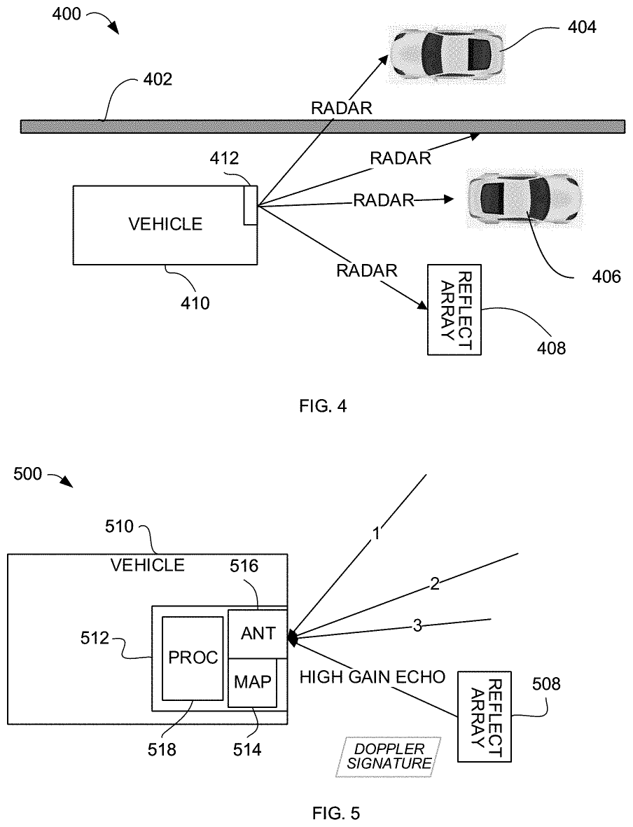

There are a variety of ways for a vehicle having sensor and communication capabilities to capture information in the environment. FIG. 4 illustrates a vehicle 410 having a radar module 412 for detecting objects in the environment 400; illustrated are beam-steered radar transmissions covering a field of view in front of the vehicle 410. The radar transmissions detect vehicle 404 and vehicle 406. The radar transmissions also are received at the reflectarray 408 which is configured to reflect radar transmissions at a given level of gain for signals received at a set of incident angles. The radar module 412 receives reflections from the reflectarray 408 at a higher amplitude level than those from vehicles 404, 406, and is able to identify the reflections as coming from reflectarray 408. In some examples, the amplitude level or differential in the reflections from reflectarray 408 indicates a specific content wherein a mapping of amplitude level to content is stored in the radar module 412. A first amplitude level reflection may correspond to a 30 mph speed limit, while a second amplitude level reflection may correspond to a 60 mph speed limit. A variety of contents and mappings may be implemented. In this way, the amplitude of reflection codes the speed limit or other information. In some embodiments, the reflected frequency is used to code information, such as where the speed limit is a function of frequency.

FIG. 5 illustrates interactions of a vehicle in a transportation environment, such as in FIGS. 3, 4 in accordance with various examples of the present disclosure. The vehicle 510 includes a radar module 512 including a mapping module 514. The radar module 512 includes an antenna 516, a processing module 518 for radar signal generation, receipt and processing, and a mapping unit 514 to store RFID content. The vehicle 510 interacts with reflectarray 508, wherein radar unit 512 identifies an RFID device by a high gain echo or reflection which may also include a Doppler signature indicating a stationary object.

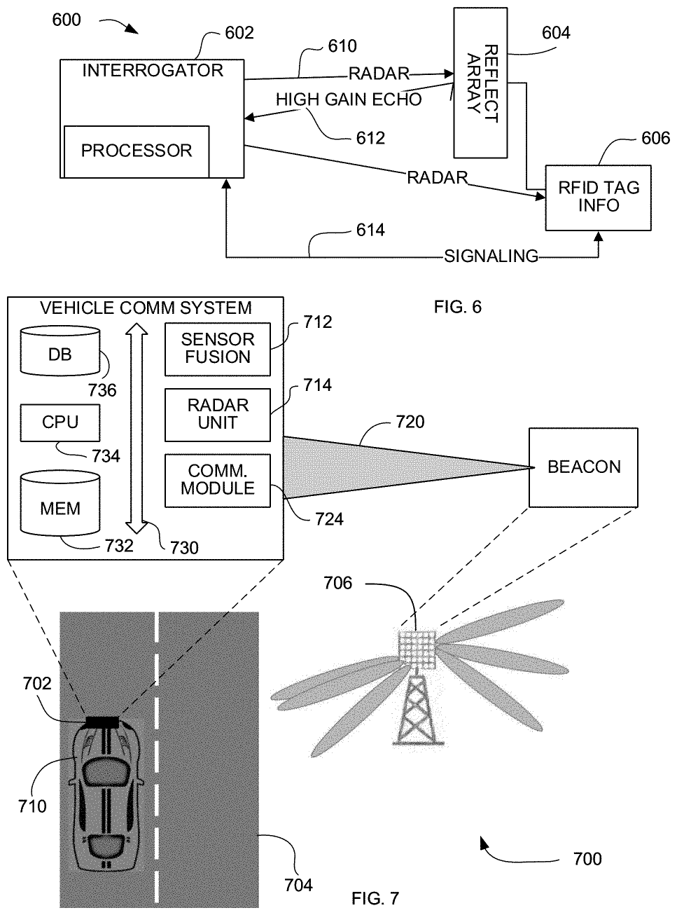

FIG. 6 details an inductive system for vehicle information capture in a transportation environment in accordance with various examples of the present disclosure for system 600. An interrogator 602 initiates an information exchange or verification by a radar signal 610 to a reflectarray 604. In this example, the reflectarray 604 is part of an RFID system where RFID tag information 606 is stored with the reflectarray 604. The reflectarray 604 reflects the radar signal 610 with a high gain echo 612 (described hereinabove) and initiates a signaling process between the interrogator 602 and the RFID tag 606. The interrogator 602 sends a specific frequency signal to the RFID tag 606 and in response the RFID tag 606 transmits the content stored therein, signaling 614.

FIG. 7 illustrates a communication system 700 for information exchange with a vehicle 710 in accordance with various examples of the present disclosure. The system includes a high frequency, directed beam transmitter 706 that generates a beacon signal 720 to be received by communication modules and in particular vehicles traveling in the area. Vehicle 710 includes a communication system 702 having radar and communication capabilities for object detection, environmental analysis, networked communications and control of the vehicle 710. The vehicle communication system 702 includes a sensor fusion 712 to access, interpret and process sensor information from a variety of sensors, including radar unit 714. The vehicle communication system 702 also includes a communication module 724 to interface with a communication network of transmitter 706. The communication system 702 includes a memory storage device 732 to maintain operation during processing, a central processing unit (CPU) 734 and a database 736 map of sensor information and actual real world conditions, such as conditions impacting the roadway 704, the path of the vehicle, control or other information supplied by the infrastructure.

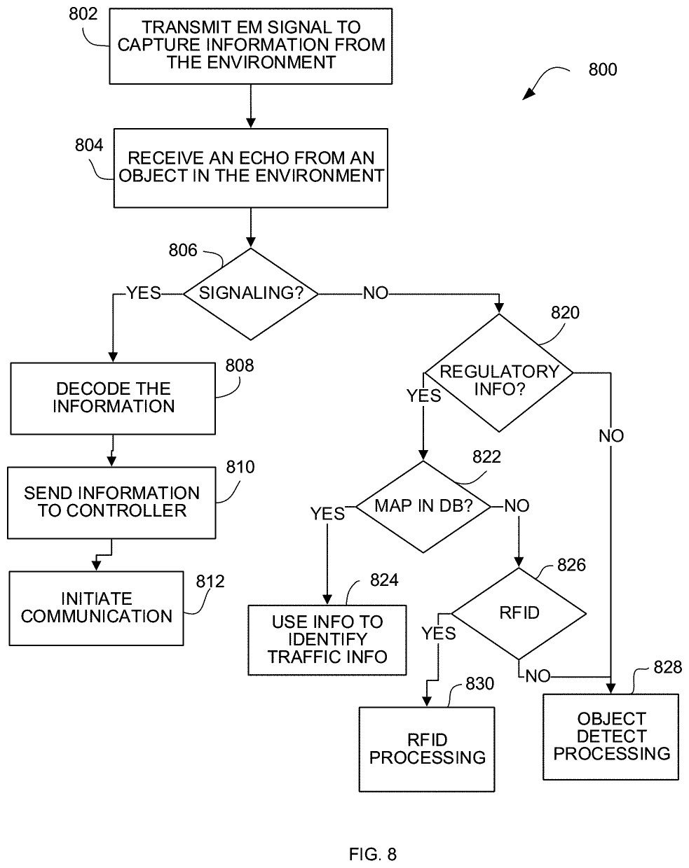

A process 800 for the vehicle 710 to acquire environment information is illustrated in FIG. 8 where the vehicle transmits an electromagnetic radiation signal to capture information in the environment, 802. This may be a radar signal, a communication signal, a laser or optical signal and so forth. The vehicle then receives an echo from an object in the environment, 804. If the echo indicates there is signaling information capability with the detected object, 806, then the vehicle decodes the information 808 and sends the information to a controller 810, which may initiate a communication, 812, within the environment where applicable. Else, if there is no signaling available, 806, the process checks for regulatory information, 820, such as road sign information embedded in a reflectarray, and if so looks for a mapping in a database, 822. If there is such a mapping, then the vehicle uses the information to identify traffic conditions, 824. If there is no mapping, the process checks for RFID capability, 826, and processes the RFID, 830. Else, the process performs object detection, 828, such as radar or lidar.

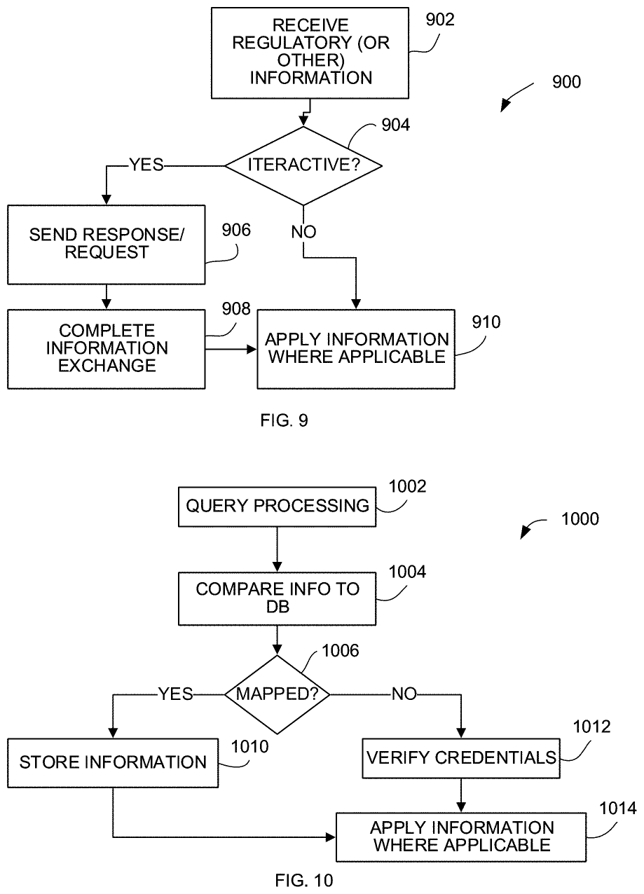

FIG. 9 illustrates process 900 for managing regulator information, such as traffic instructions or controls. The regulatory information is received, 902, and if the information is acquired by an interactive method, 904, processing sends a response or request for information, 906 and completes the information exchange 908. If the information is not interactive, 904, and after complete information exchange, 908, the process 900 applies information received as applicable, 910. In this way, if the vehicle is able to communicate with the object storing regulatory information, it may initiate communication and exchange information. If there is no interaction, but the received information, such as a high gain echo, contains regulatory information, then that information is determined and applied.

Process 1000 of FIG. 10 is another process for vehicle operation. In process 1000, a vehicle may initiate query processing 1002, such as steps 906, 908 of FIG. 9. Received signals are compared to a database or look up table (LUT) or mapping device to find content corresponding to the received signal(s). If there is no correspondence (no mapping), then the process verifies the information and credentials 1012 to verify that the received signals correspond to a specific content and then the information is applied, 1014. If there is a correspondence, 1008, the information is store, 1010, as a current condition in the environment.

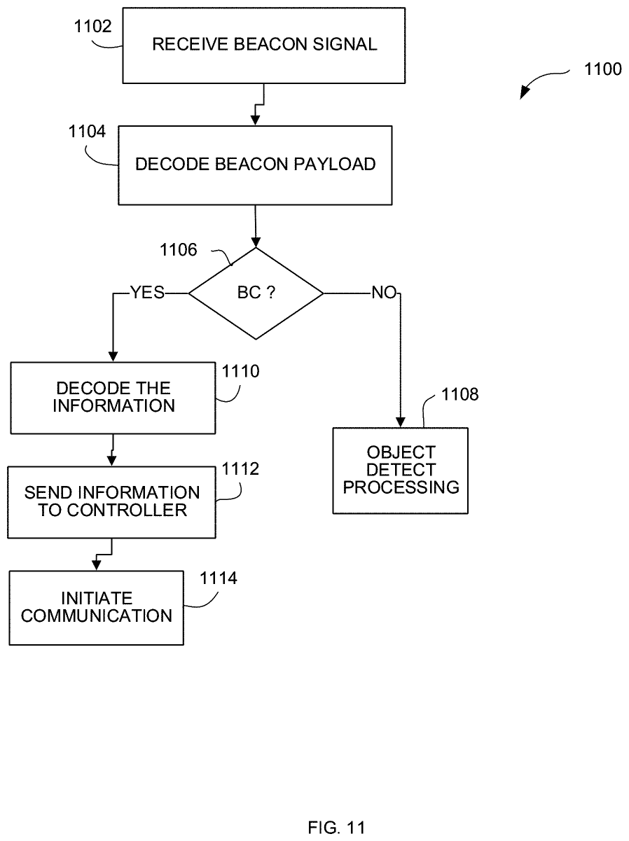

FIG. 11 illustrates a process 1100 for vehicle operation in response to a beacon signal in accordance with various examples of the present disclosure. In this process, the vehicle receives a beacon signal, 1102, and decodes the beacon, 1104. If the information was sent via a broadcast (BC) transmission to multiple vehicles, 1106, the recipients decode the information, 1110, which may be to map the receive payload data to environmental condition(s) that may include traffic regulatory messages, weather conditions, and so forth. This information is sent to a controller 1112, and optionally, a communication is initiated with the environmental transmitter of the BC signal, 114. If this is not a BC transmission, 1106, then other methods of object detection processing 1108 continue. Note that in many of these various scenarios redundancy is applied for increased accuracy and security; therefore, while illustrated as individual separate paths, some paths in the processes disclosed herein may include multiple parallel paths operating simultaneously or in sequence.

Returning to the examples of FIGS. 4 and 5, a vehicle travels in environments having reflectarrays 408, 508, respectively, which are stationary in the environments 400, 500, respectively. In alternate implementations, these reflectarrays may be mobile and or temporary stationary modules depending on the application. The design of these reflectarrays is specific to a transmission system, environment, geographical layout, NLOS areas, and beam specifics. There are input constraints as the reflectarrays are designed assuming little to no ability to control the transmission parameters, incoming signal, and the required output signal to cover a target area. In some examples, the space available for the reflectarrays is also limited, as are the materials and composition, such as for use in extreme weather conditions, or in very tight courtyards and so forth. The reflectarrays are a redirection structure to change the direction of over the air (OTA) signals incident thereon, and in some examples, to amplify the transmission on redirection.

FIG. 12 illustrates a method for designing a redirection structure, such as a reflectarray. While described for a passive structure, the redirection structure contains active components to enable amplification of a signal for increased range and so forth. In this example, a flow chart illustrates a design, configuration and calibration process 1200. The process starts by determining a reflection point or reflection area, 1202, described by azimuth and elevation angles from a reference position such as boresight. Where boresight is used as reference, a beam directed perpendicular to the x and y directions of the plane, and along the z axis defines the reference direction. Using the reference angles, the process calculates a reflection phase, φᵣ, for reflector element (i) to the reflection point, 1204. As illustrated in FIG. 12, the directed reflection is a composition of the entire array of tiles, or a subarray of the tiles, wherein each tile contributes to that directed reflection beam. The process uses equation 1206 for these calculations, with the equation 1206 given as:

Ψᵣ=k₀(dᵢ−(xᵢ cos ϕ₀+yᵢ sin ϕ₀)sin θ₀)±2Nπ (Eq. 1)

wherein k₀ is free space propagation constant, dᵢ is the distance from the transmitter to the i^{th} element, N is an integer, and the target reflection point is identified by an angle in azimuth (φ₀) and an angle in elevation (θ₀) from the directed reflectarray to the target reflection point. The calculation 1206 identifies a desired or required reflection phase φᵣ by i^{th} element on the xy plane to point the array beam to (φ₀, θ₀). dᵢ, is the distance from the phase center of the transmitter to the center of the i^{th} element, and N is an integer. This formula and equation may further include weights to adapt and adjust specific tiles or sets of tiles. In some examples, a reflectarray may include multiple subarrays allowing redirection of a received signal in more than one direction.

The process 1200 then determines the shape and combination of reflector array elements, referred to herein as tiles, 1210, and then determines the number of tiles, 1212 and their positions, 1212. If the configuration is accurate, 1218, the processing continues for the next tile. Else, the process determines a correction 1220 and recalculates. A correction may be to weigh some of the tiles, or to add a tapering formulation and so forth.

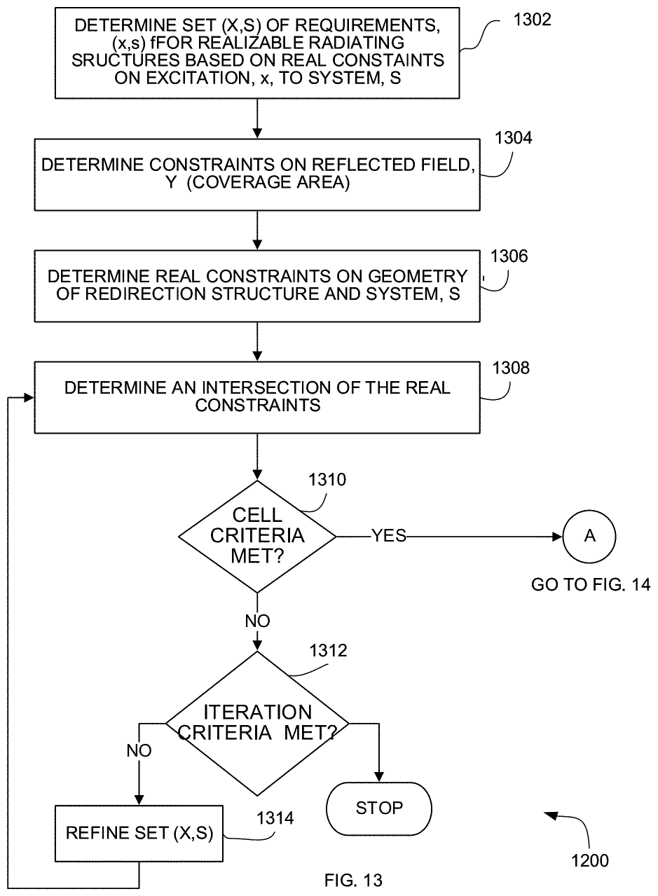

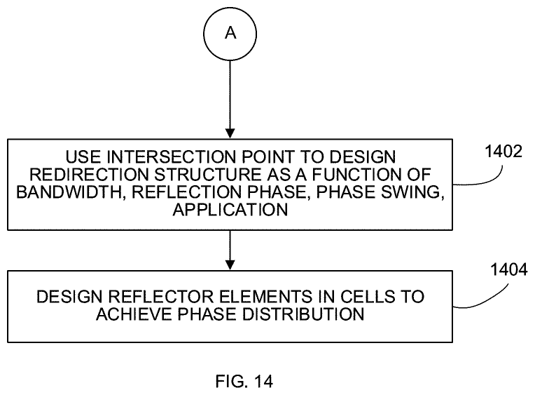

FIG. 13 illustrates a method 1300 of designing the cells within a redirection structure. First, determine a set of requirements for the redirection structure, including constraints on the incident wave excitation (X) and the structure (S), such as geometric constraints, 1302. The specific constrains are those to design a realizable radiating structure. The individual components of these sets are given as (x,s). Add to this the real constraints on a desired reflected field (Y) or coverage area, 1304. From this information, determine real constraints on the geometry and location of the redirection structure and system (S), 1306. The process then iterates to find an intersection of the constraints, 1308. If the result meets the cell criteria, 1310, processing continues to a next step 1402 illustrated in FIG. 14, else the process determines if an iteration criteria is met, 1312. If the iteration criteria is met without meeting the cell criteria then processing stops to reevaluate the initial criteria and any assumptions made. If the iteration criteria is not met then the process refines the set (X,S) and returns to determine a new intersection, 1314.

The process continues to FIG. 14 to use an intersection point to design redirection structure as a function of bandwidth, reflection phase, phase swing and application, 1402. The process then designs redirection structures and elements in cells to a achieve phase distribution, 1404. The processes implements the system model for excitation, X, to System, S, and resulting in reflected field, Y.

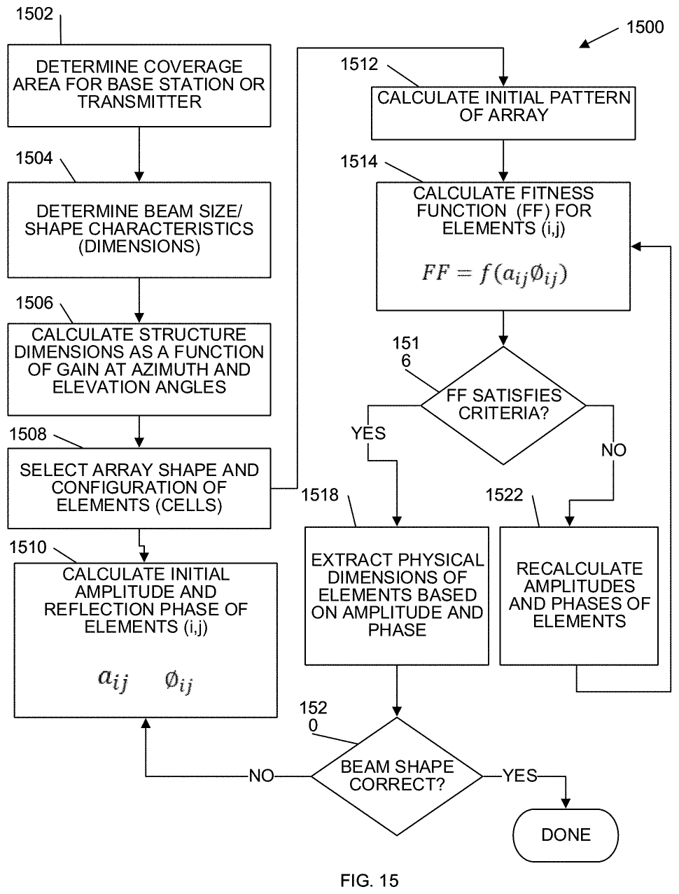

As described herein, FIGS. 12, 13, 14, 15 illustrate example processes for design of a reflectarray in accordance with various examples of the present disclosure. The process 1500 of FIG. 15 determines a coverage area for a base station or transmitter, 1502, and then determines beam characteristics and dimensions for target area 1504. This enable calculation of structure dimensions as a function of azimuth and elevation angles, 1506. The process then selects an array shape and configuration of elements or cells, 1508, and calculates initial amplitude and reflection phase elements (i,j) of the structure, 1510. By calculating an initial pattern of the array, 1512, and the fitness function (FF) for elements (i,j), the process determines if the FF is satisfied, 1516, and extracts physical dimensions of elements and configuration based on amplitude and reflection phase, 1518. If the beam shape is correct, 1520, the process is complete, else processing returns to recalculate amplitude and reflection phase, 1510. If the FF does not satisfy criteria, 1516, then the process recalculates amplitude and phases of elements and then recalculates the FF for elements, 1514.

The processes and methods described herein may be implemented as software, firmware, or other computing instructions implemented in a processing unit. In some embodiments, such processes are implemented in hardware, such as an ASIC or dedicated circuit.

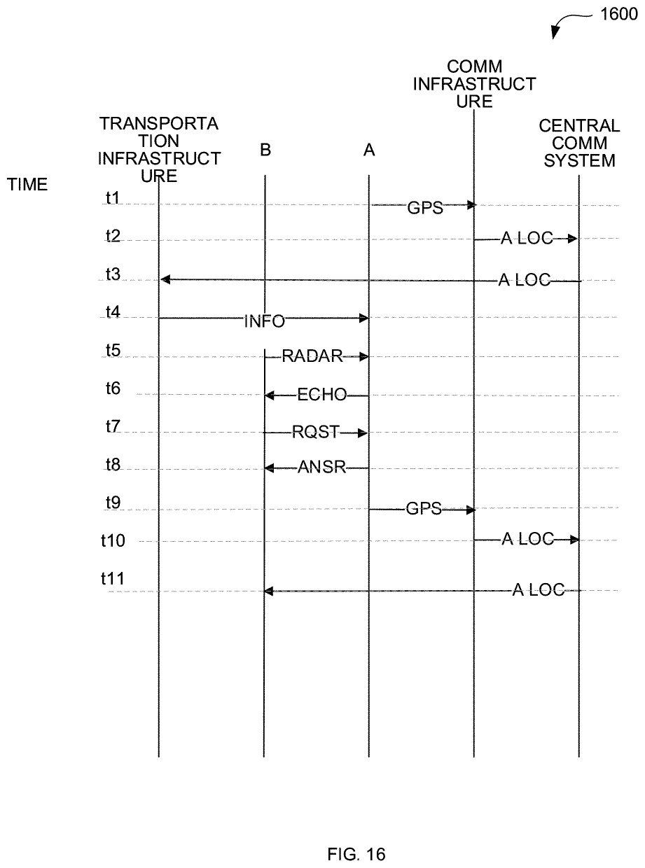

FIG. 16 illustrates signal timing diagrams for various scenarios in accordance with various examples of the present disclosure for an environment having a transportation infrastructure, a communication infrastructure operating in coordination with a central communication system and vehicles A and B moving therein. At time t1, vehicle A sends a GPS signal to communication infrastructure which then transmits the location of vehicle A to a central communication system at time t2. The location of vehicle A is then sent to transportation infrastructure, such as a road sign element, at time t3, wherein the transportation infrastructure sends information to vehicle A, such as road conditions or instructions, at time t4. Vehicle B may detect vehicle A at time t5 by radar transmission and echo received at time t6. When vehicle to vehicle (V2V) communications are enabled, vehicle B sends a request to vehicle A at time t7 and an answer is returned at time t8.

In another scenario, vehicle A sends GPS information to communication interface at time t9, which may be sent periodically or may be triggered by a condition in the environment. The GPS information identifies a location of vehicle A, which is then sent to central communication system at time t10. The central communication system then sends the location information of vehicle A to vehicle B, enabling vehicle B to verify other sensor information and object detection means of vehicle B; if vehicle B has not detected vehicle A, the location information from the communication system provides vehicle B with expanded information. Note, as described in FIG. 16, the communications, information exchanges, GPS transmissions and so forth are illustrated with respect to vehicles, however, such communications may also occur from cell phones and devices having wireless capabilities, enabling vehicles and others to identify a person or machine at a given location.

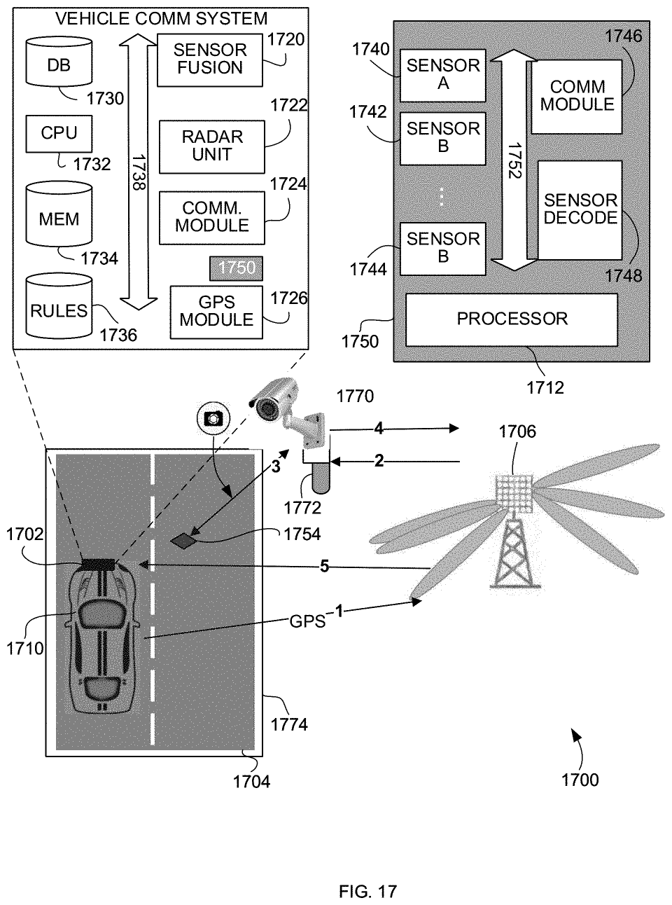

FIG. 17 illustrates a sensor system in accordance with various examples of the present disclosure. The sensor system 1702 is part of a vehicle 1710 in environment 1700. The vehicle 1710 is traveling along a smart road 1704 having embedded informational devices. Vehicle communication system 1702 includes a communication bus 1738 which may be implemented in a variety of ways to enable communication through the system 1702, including dedicated routing, ASIC and so forth. The system 1702 also includes a sensor fusion 1720 to coordinate sensors within the system 1702. Sensors include a radar unit 1722 and connections to sensor module 1750, which includes multiple type sensors 1740, 1742 through 1744, a sensor decode module 1748, a communication module 1746 and internal communication means 1752. The sensor information from the variety of sensors is used in sensor fusion 1720. The radar unit 1722 includes radar signal generation and interpretation as well as antennas for transmit and receive. The vehicle communication system 1702 also includes a database 1730 for storing information that may correspond to information received from sensors or communication module 1724, GPS module or other. The rules module 1736 applies rules to sensor fusion 1720 control of the vehicle as well as mapping of rules corresponding to information received from the environment. Central processing unit (CPU) 1732 controls operation within the system 1702 including access to memory 1734.

The environment includes a cellular communication system having base station 1706 operating in a directed beam mode which steers beams to specific users and/or coverage area. The environment also includes a roadside camera 1770 directed to positions on the smart road 1704 having tag 1754 with information about the roadway and environment. In various examples, the roadway implements a dynamic speed limit for vehicles in the area. In other examples, the tag 1754 stores information on weather conditions, such as conditions for icy roads, and so forth. The tag 1754 may store any of a variety of information that a driver may need to access. The tag may be read by a camera 1770 or other sensor unit 1772, which captures the information and transmits the same to communication BS 1706.

As illustrated in FIG. 17, a camera sensor 1770 is illustrated for ease of understanding; it is understood that different sensors may be implemented, including radar, lidar, Wi-Fi, RFID, and so forth. In an example situation, a vehicle 1710 enters a geofenced area 1774. There are a variety of ways for the geofenced area 1774 configuration, wherein entry of a vehicle triggers actions to communicate information to the vehicle. The geofence may be monitored by a sensor in the environment, such as a motion sensor or other means, which then activates a process for communicating with the entrant. In this situation, the vehicle 1710 enters geofence 1774 and sends a GPS signal to the communication system 1706 identifying its location. The entry into the geofence area 1774 may be a programmed capability linked to mapping stored in the vehicle, may be identification of a marking or other indication of the geofence, may be received from a BC or multi-cast (MC) type signal from a wireless communication system and so forth.

The vehicle 1710 sends GPS information as signal 1 to system 1706, which responds by sending an instruction to the camera 1770 to capture a current state of the tag 1754, signal 2. This is then captured, signal 3, and transmitted to the system 1706, signal 4. This information is then transmitted to the vehicle 1710, signal 5. The information of the tag may be decoded in the camera module 1770, the communication system 1706 or in the vehicle communication system 1702. Where relevant, the vehicle sensor fusion 1720 receives the information from tag 1754, which may indicate a traffic condition, a road condition, toll information and so forth. The vehicle is able to use this information to make decisions and take actions, such as to change direction, pay a toll, increase caution to avoid poor road conditions, alert to changing traffic lights, construction zones, alert to a vehicle behaving in a manner of a drunk driver, and so forth. The smart road tags may be implemented in the roadway, on the side of the road, or in a drone overhead. In some examples, vehicles or drones move through an environment with smart tags through which information is provided to vehicles and drivers, as well as captured for other purposes, including traffic analysis, fugitive capture and so forth. The information of a smart road tag may be static information, such as to indicate speed limit or route identification. In some examples, the tag content may be updated, so as to show current conditions or detours and so forth.

Also illustrated in FIG. 17 is a sensor 1772, which may be a reflectarray which indicates there is information to be read or acquired from the infrastructure. The vehicle 1710 transmits a radar signal, steering the beam across a range of angles, wherein when a radar beam is incident on the reflectarray the beam is reflected with a higher gain than that of other objects. This high gain return indicates there is additional information available. This information may be encoded in the gain level of the reflectarray, or may trigger a further sensor in the vehicle, such as a camera, lidar, wireless communication and so forth to capture the information stored in the infrastructure.

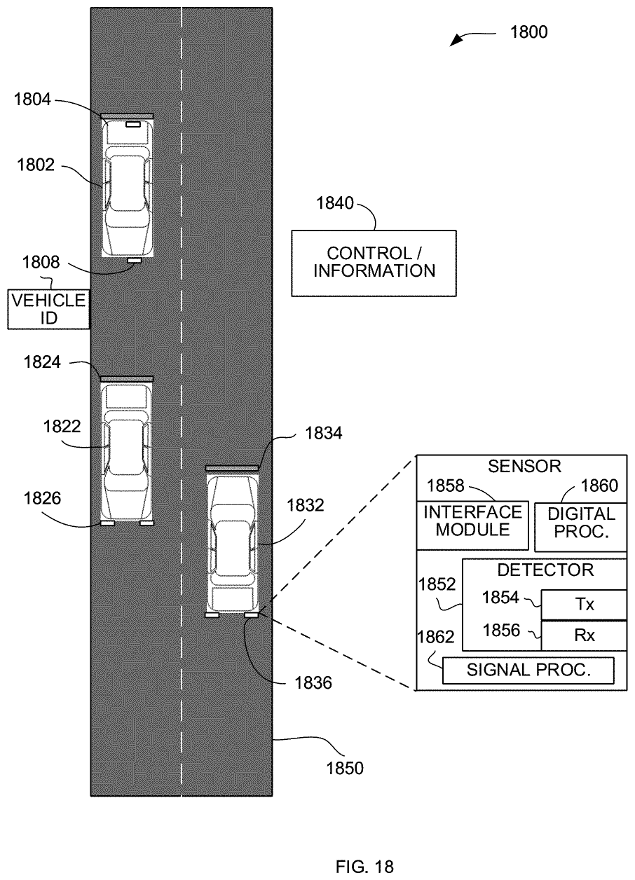

FIG. 18 illustrates a transportation system with vehicles having multiple sensors and communication devices in accordance with various examples of the present disclosure. The environment 1800 includes roadway 1850 with vehicles 1802, 1822, 1832 in motion. The vehicle 1832 includes sensor modules at the front and rear of the vehicle, such as sensor 1836, 1834. The sensor 1836 includes an interface module 1858, a signal processing module 1862, a digital processing module 1860, and detector 1852, such as a radar module. The detector 1852 includes transmit circuitry 1854 and receive circuitry 1856, enabling detection of objects in the rear of the vehicle.

The vehicle 1802 includes a vehicle ID module 1808 which may be an RFID or other system for providing vehicle information to other vehicles or devices within the environment 1800, wherein vehicle information may be a license plate number, or other identification. There may be control information stored in infrastructure 1840 to be accessed by a sensor/communication module 1804 on vehicle 1802. The vehicle 1822 also includes a forward sensor/communication module 1824 and rear facing module 1826. The various sensors and communication modules may coordinate with each other and may coordinate with the infrastructure and smart road devices.

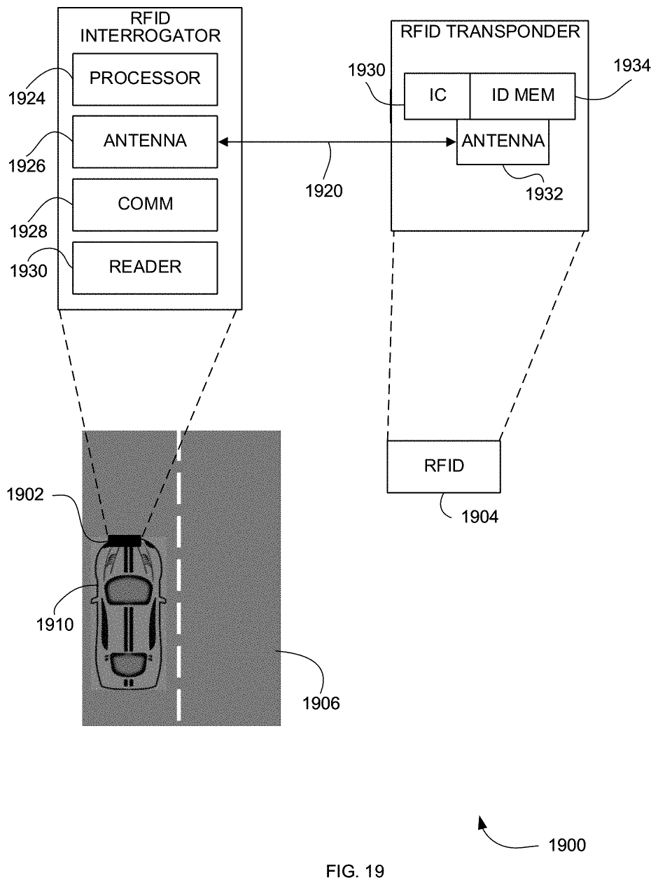

FIG. 19 illustrates a transportation environment 1900 having roadway 1906 and RFID structure 1904, which is illustrated as a stand-alone structure but may be positioned on a building or other structure. The RFID structure 1904 stores information for traffic control and/or information. A vehicle 1910 is traveling through environment 1900 and has an RFID interrogator module 1902. In this example, the RFID structure 1904 acts as an RFID transponder storing an information tag. The vehicle 1910 acts as the RFID interrogator. The RFID module 1904 includes an integrated circuit (IC) 1930 controlling operation of the RFID module 1904, an antenna 1932 receiving signals and transmitting information. The traffic control and/or information is stored as a tag in ID memory 1934. When the antenna 1932 detects a request from an interrogator, the IC 1930 acts to retrieve the identity from ID memory 1934 for transmission in response to the interrogator.

The vehicle 1910 includes an RFID interrogator module 1902 having a processor 1924, an antenna 1926, a communication module 1928, and a reader 1930. The RFID interrogator 1902 sends a request from the antenna 1926 and receives responses, which are processed within the module 1902. The reader 1930 is configured to interpret the ID information received from transponder 1904 and may need to communicate with a separate system via communication module 1928 for additional information. The vehicle 1910 uses this information to identify traffic conditions and so forth.

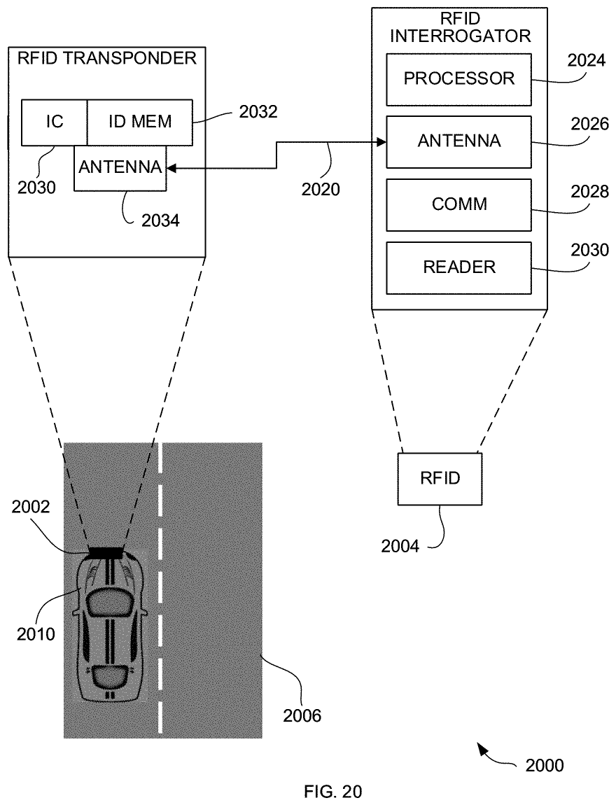

FIG. 20 illustrates a scenario similar to that of FIG. 19 with the RFID structure 2004 as an interrogator and a module 2002 on a vehicle 2010 as the RFID transponder. Within the environment 2000 a roadway 2006 has an RFID structure 2004 positioned proximate and adapted to read vehicle IDs. The RFID structure 2004 is an RFID interrogator with a processor 2024, an antenna module 2026, a communication module 2028 and a reader 2030. The RFID structure 2004 sends a request to vehicle 2010 which is received by the antenna 2034 of RFID transponder 2002. The ID memory stored in memory 2032 is retrieved by IC 2030 and transmitted as an answer by antenna 2034 to RFID structure 2004. In this way, the transportation infrastructure is able to access vehicle ID information. The examples of FIGS. 19 and 20 may have actions triggered by geofences or other location indicators.

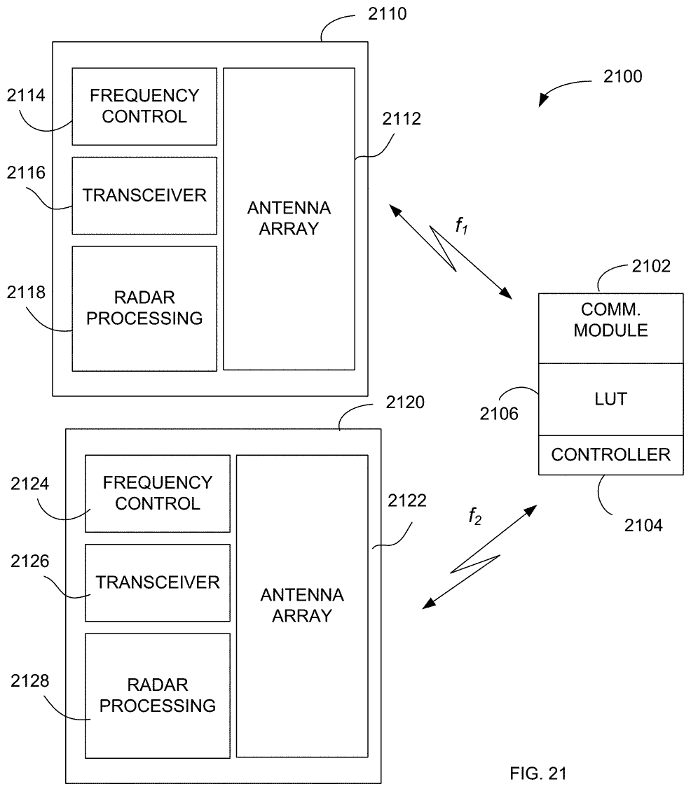

FIG. 21 illustrates a system 2100, in accordance with various examples of the present disclosure. The system 2100 includes radar unit 2110 and radar unit 2120. The radar unit 2110 includes a frequency control 2114, a transceiver 2116, a radar processing 2118, and an antenna array 2112. The radar unit 2120 includes a frequency control 2124, a transceiver 2126, a radar processing 2128, and an antenna array 2122. The radar unit 2110 and radar unit 2120 are communicatively coupled to communication module 2102, LUT 2106, and controller 2104 via f1 and f2, respectively.

The present disclosure provides methods and apparatus for vehicle sensors and vehicle identification. Some methods incorporate reflectarrays to indicate information is available, some use geofencing to trigger actions, some incorporate synergy between vehicles, some use smart tags in roads, and so forth.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A vehicle sensor system, comprising:
a radar module; and
an inductive sensor module having a decode module to extract content from a sensor signal.

2. The vehicle sensor system as in claim 1, wherein a sensor signal is a radio frequency identification (RFID) signal.

3. The vehicle sensor system as in claim 2, wherein the inductive sensor module further comprises an RFID interrogator module adapted to transmit an interrogation signal and read a return signal from an RFID tag.

4. The vehicle sensor system as in claim 3, wherein the return signal is a traffic instruction.

5. The vehicle sensor system as in claim 4, wherein the traffic instruction is a speed limit indicator.

6. The vehicle sensor system as in claim 5, further wherein the radar module comprises:
an antenna array adapted to receive electromagnetic signals;
an amplitude detection module to detect electromagnetic signals above a threshold value; and
a controller adapted to provide a control signal to the inductive sensor on detection of electromagnetic signals above the threshold.

7. A traffic infrastructure element, comprising:
a reflectarray having a reflection distribution for incident electromagnetic signals to reflect at a first gain value; and
a radio frequency identification (RFID) tag module responsive to RFID transmissions from a reader device, wherein the RFID transmission activates the RFID module to return data to the reader device.

8. The traffic infrastructure element as in claim 7, where the RFID tag module comprises a transponder.

9. The traffic infrastructure element as in claim 8, wherein the return data corresponds to an instruction to the reader device.

10. The traffic infrastructure element as in claim 9, further comprising:
a storage device having traffic control information stored therein.

11. An inductive system for vehicle information capture, comprising:
a radar module adapted to identify an echo signal having an amplitude over a threshold value;
an interrogator module coupled to the radar module and adapted to initiate a radio frequency identification (RFID) information exchange when the amplitude is over the threshold value;
a processor coupled to the radar module and the interrogator module; and
a memory storage unit adapted to store RFID information.

12. The inductive system as in claim 10, wherein the echo signal corresponds to an echo from a reflectarray element.

13. The inductive system as in claim 11, wherein the interrogator module transmits an interrogation signal to a RFID tag positioned proximate the inductive system.

14. The inductive system as in claim 12, wherein the processor maps the RFID tag information to traffic information stored in the memory storage unit.

15. The inductive system as in claim 13, wherein the radar module sends a signal to the interrogator module to start RFID processing.

16. The inductive system as in claim 11, wherein the radar module comprises:
an antenna array; and
a beam steering module coupled to the antenna array.

17. The inductive system as in claim 16, further comprising a communication module and a controller.

18. The inductive system as in claim 17, wherein the communication module is adapted to transmit a request for information to an infrastructure element.

19. The inductive system as in claim 18, wherein the communication module provides the information from the infrastructure element to the controller, wherein the controller determines an action for a vehicle.

20. The inductive system as in claim 19, wherein the information is a speed limit indicator.
